(19) United States
(12) Patent Application Publication
(10) Pub. No.: US 2005/0255440 A1
(43) Pub. Date: Nov. 17, 2005

(54) System and method of integrating levels of educational programs

(76) Inventor: Linda Proctor Downing, Phoenix, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/070,316

(22) Filed: Mar. 1, 2005

Related U.S. Application Data
(60) Provisional application No. 60/570,906, filed on May 12, 2004.

(51) Int. Cl. G09B 7/00

(52) U.S. Cl. 434/362

(57) ABSTRACT

An integrating high school and college program gives student the opportunity to receive a high school diploma and earn college credit. The high school is located in proximity to a college campus in order to share resources and facilities. The student is evaluated to ascertain academic aptitudes and capabilities. The evaluation involves administering a college placement exam and reviewing prior school transcripts. An administrator of the high school assigns a class schedule to the student based on the assessment of the student. The class schedule has a combination of high school classes and college classes. The high school class is scheduled in accordance with the college class. The student attends the high school class and college class according to the class schedule. The student earns college credit upon passing the college class. The high school offers special classes for the student to adapt to the college classes.

### CLAIM TO DOMESTIC PRIORITY

The present non-provisional patent application claims priority to provisional application Ser. No. 60/570,906, entitled “Method of Combining High School with College Teaching”, filed on May 12, 2004.

### FIELD OF THE INVENTION

The present invention relates in general to educational systems, and more particularly, to a program and method of integrating levels of educational programs.

### BACKGROUND OF THE INVENTION

The education system in the United States and most industrialized countries is highly structured and generally inflexible in favor of using a long-established logical process designed to take the student through a myriad of stepwise subjects and classes to provide a set of skills in preparation for adult life. In the common progression, the student enters pre-school or grade school and then advances to middle school or junior high school. In most jurisdictions, the grade school through middle school process, i.e., grades 1-8, takes about eight or nine years. The students are exposed to history, geography, sciences, English, mathematics, art, music, as well as other subjects to prepare for the high school years. In high school, the students take similar classes at a more advanced level to prepare for college. The students are exposed to the traditional high school curriculum in grades 9-12, which typically takes four years to complete.

From high school, many students attend college, either by enrolling in a four year university or by attending a community college for two years and then transferring to the four year university. The community college or university setting will have some general coursework required of all students, e.g., English, humanities, economics, and basic math and science. The college student relatively quickly engages in the course work of their selected degree program. By the end of the college program, the student is totally immersed in their chosen academic discipline.

Because of non-standardization and inconsistencies in lower education across jurisdictions, some college departments, e.g., mathematics and English, require entering college freshman to take one or more placement exams. The placement exams are generally given immediately prior to registration, e.g., when the student having just graduated from high school is preparing to register for freshman college classes. The placement exams are intended to take students from a variety of programs and jurisdictions and confirm that they are properly placed within the new school's stepwise program. Still, the placement exams are generally given only once to students entering the subject educational level, i.e., entering college freshmen.

In most cases, the grade school is geographically and administratively isolated from the middle school. Likewise, the middle school is geographically and administratively isolated from the high school, and the high school is geographically and administratively isolated from the college. The physical separation between levels of education is intentional and done by design. Traditional school administrative thinking prefers to isolate adjacent educational levels to avoid undesirable influences and interaction between the schools. It is generally held that middle school students must be protected from exposure to high school students, and high school students do not have the requisite maturity to be part of the college population.

As a result, the vast majority of students are herded through a strictly regimented and stepwise regulated education system, in most cases, regardless of their individual capabilities, aptitudes, and desires. The student completes the ninth grade curriculum before entering the tenth grade, and then completes the tenth grade curriculum before entering the eleventh grade, and then completes the eleventh grade curriculum before entering the twelfth grade, and then completes the twelfth grade curriculum before entering college. Even those individuals who skip a grade, i.e., enroll in a higher grade level in advance of their years, do so by leaving behind the prior curriculum and entering the same basic stepwise system, just at a high rung on the educational ladder. Students that jump ahead find themselves in the same basic regimented educational system, just with an older crowd and sometimes lacking the maturity for the new level of academic rigors and social interaction. The quantum advance may in fact work against the student as he or she may excel in some subjects and be no better than average in other subjects. The student may quickly find themselves overextended in the subjects of lesser aptitude while trying to function at a level which is higher the across the board of coursework.

To avoid such problems, most school administrators adhere to the philosophy that high school and college are two entirely different institutions, and most students need to stay where they age-wise belong. Most educators believe that there are high school courses and there are college courses, and academic overlap and joint participation should be minimized. Each educational level (high school or college) and each grade within such educational level should be discrete steps. Most parents have the same mindset, in part because that is the process they went through. Administrators are reluctant to mix and match these discrete educational steps for fear of adversely impacting the progress of the student and upsetting the bureaucracy of the system, i.e., co-mingling between educational levels disturbs the well excepted flow of the system. College courses are fundamentally different in terms of subject matter, classroom environment, styles of teaching, and expectations of students. Therefore, educators prefer high school students to have a certain level of academic preparation, age, and maturity in order to increase chances of being successful in college courses.

While there may be some truth or at least reality to this view, the present educational system simply does not reflect individuality of student progress and capability. The present system is fundamentally a regimented stepwise program which is designed for the average student to be able to circumscribe. While certain at-risk students may struggle in any system, the exceptional ones are likely held back to the pace of the center of the normal distribution. The result is a system that follows old standards of identification and progression, and becomes a rite of passage more than an optimized educational experience. A basic shortcoming of the present education system is that there is little or no interaction or integration between different levels of education, and indeed a deep rooted bias against such notions.

### SUMMARY OF THE INVENTION

In one embodiment, the present invention is a method of integrating high school and college curriculum to allow a student to receive a high school diploma and earn college credit, comprising providing a high school in proximity to a college campus, evaluating a student to ascertain academic aptitudes and capabilities, assigning a class schedule to the student based on the evaluation of the student, the class schedule having at least one high school class and at least one college class, and organizing a high school forum wherein the student attends the high school class in the high school and attends the college class on the college campus according to the class schedule.

In another embodiment, the present invention is a computer implemented method of providing a high school forum integrated with a college curriculum, comprising administering an assessment test to high school students at least once per year, evaluating the high school student based on the assessment test to determine a class schedule based on academic aptitudes and capabilities, the class schedule having a high school class and a college class, and organizing the high school forum in a manner to allow the student to attend the high school class and college class according to the class schedule.

In another embodiment, the present invention is a method of educating a high school student in a high school forum located in proximity to a college campus, comprising assessing academic competence of the high school student by administering an assessment test, assigning a class schedule to the high school student based on the academic competence, the class schedule having a high school class and a college class, organizing the high school forum so that the high school student attends the high school class under the high school forum and the college class on the college campus, and awarding college credit to the high school student upon passing the college class.

In another embodiment, the present invention is an integrating high school and college program which allows a student to receive a high school diploma and earn college credit, comprising means for providing a high school in proximity to a college campus, means for evaluating a student to ascertain academic aptitudes and capabilities, means for assigning a class schedule to the student based on the evaluation of the student, the class schedule having at least one high school class and at least one college class, and means for organizing a high school forum, wherein the student attends the high school class in the high school and attends the college class on the college campus according to the class schedule.

### BRIEF DESCRIPTION OF THE DRAWINGS

FIG. 1 illustrates an educational system;

FIG. 2 illustrates a high school forum in close proximity to a college campus;

FIG. 3 illustrates the high school forum co-located on the college campus;

FIG. 4 illustrates the integrated high school and college program;

FIG. 5 illustrates results of a first assessment examination;

FIG. 6 illustrates results of a second assessment examination;

FIG. 7 illustrates transcripts of a student transferring from another school;

FIGS. 8a-8b illustrate transcripts of a student from the integrated high school and college curriculum;

FIG. 9 illustrates a first high school lesson plan under the integrated high school and college curriculum;

FIGS. 10a-10c illustrate a second high school lesson plan under the integrated high school and college curriculum;

FIG. 11 illustrates a process of integrating high school and college curriculum to allow a student to receive a high school diploma and earn college credit;

FIG. 12 illustrates a general computer system for integrating the high school and college curriculum; and

FIG. 13 illustrates a computer communication network for integrating the high school and college curriculum.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

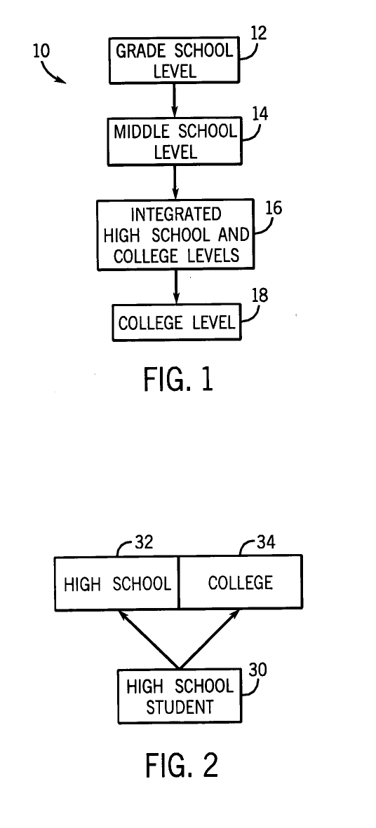

Referring to FIG. 1, an educational system 10 is shown suitable for educating students. The educational system 10 has a grade school level 12, middle school level 14, and integrated high school and college level 16. While the integration between education levels is shown and described between high school and college, similar principles can be applied to an integration between the grade school level and middle school level, or between the middle school level and the high school level.

The student enters pre-school or grade school level 12 as a child around the age of 5 or 6 and undertakes the prescribed coursework. Upon demonstrating satisfactory progress under the requisite grade school level coursework, the student advances to middle school level 14. In most jurisdictions, the grade school through middle school levels, i.e., grades 1-8, takes about eight or nine years. The student is exposed to history, geography, sciences, English, mathematics, art, music, as well as other subjects to prepare for the later years. Again, after demonstrating satisfactory progress under the requisite middle school level coursework, the student advances to the integrated high school and college level 16. In some cases, the student will later proceed to college level 18, which may be a four year university to complete their undergraduate degree and/or pursue post graduate work.

As noted above, the traditional path for students is to complete four years of high school followed by four years of college. The high school curriculum has its defined course work, and the college curriculum has its defined course work. While the traditional high school and college process has been in effect for a long time, it is not the most cost effective or efficient system to educate our youth. In today's mounting competitive workplace, new approaches are needed to improve our educational system. Educational system 10 provides just such innovative thinking and implementation to help students get a more complete education, possibly in less time.

Educational system 10 uses an integrated high school and college level 16 to provide an effective and efficient academic environment and process for students to simultaneously earn their high school diploma and college credit. In its basic structure, educational system 10 combines portions of the high school curriculum with portions of the college curriculum to give the student the opportunity to graduate high school with a significant number of earned college credits. After high school graduation, the student may formally enter college with the earned college credits which gives the student several options. The student may choose to complete their degree program in less time and potentially start graduate school earlier than could practically have been done under the traditional approach. Since the student is starting college ahead of the game with a certain number of earned college credits, he or she may choose to take additional college courses in excess of the degree requirements during their two or four year college period to increase their overall knowledge base. In another option, the student can take college course work with fewer hours per semester, e.g., to allow time for work, and still graduate in four years. In yet another option, the student may use the college credits earned in high school to free up time so he or she can focus efforts on multiple programs of study to earn two or more degrees in the same time that the traditional program of study would have provided only one college degree. The idea is not to finish high school early, but rather to finish with a number of college credits, which will provide the head start in the next level. In any case, educational system 10 makes efficient use of high school years to prepare the student for college in ways that could not previously have been achieved.

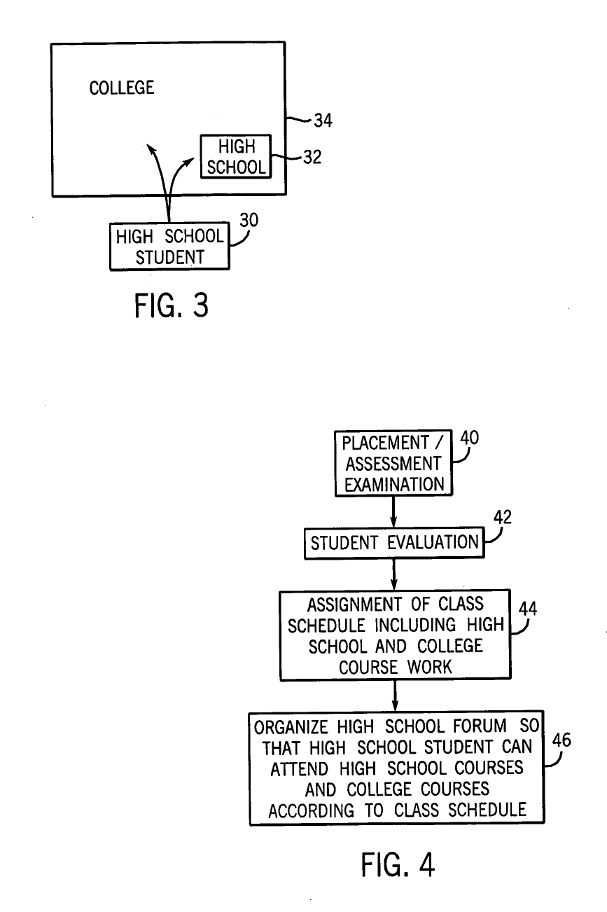

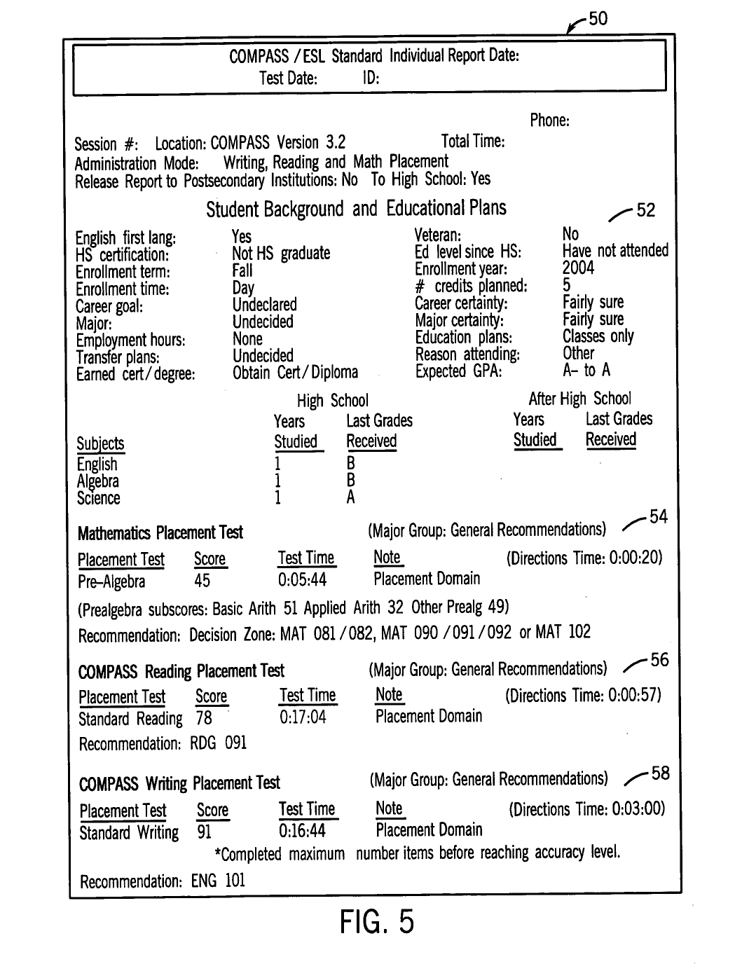

Turning to FIG. 2, assume that student 30 has completed middle school level 14 and elects to enroll in high school 32, which offers an integrated high school and college curriculum. In other cases, student 30 transfers from a traditional high school into integrated high school 32. In the present example, the high school 32 is a college preparation charter school, although the same concept applies to any public or private high school forum. In terms of physical logistics, high school 32 is located adjacent to or in sufficiently close proximity to college 34 so that student 30 can attend classes in both the high school classrooms and the college classrooms during the same school day. Alternatively, high school 32 can be co-located on the same campus as college 34 as shown in FIG. 3. Student 30 may have back-to-back classes in high school 32 and college 34 and need to be able to physically traverse the distance between the respective classrooms in a practical and safe manner. In the present example, college 34 is a two-year community college, but the same concept applies to a four-year university.

High school 32 and college 34 are separate and distinct administrative institutions. High school 32 and college 34 each follow the rules, regulation, accreditation, competency, and graduation requirements imposed by their respective governing bodies and state and local laws. The individuals enrolled in high school 32 are still high school students and the individuals attending college 34 are college students, each subject to the rules, regulations, requirements, and expectations of their respective institutions. The high school students 30 are working toward their high school diploma and the college students are working toward their college degree. As will be seen, the high school student 30 will gradate from high school 32 with more than just the diploma.

By having high school forum 32 on the same campus as college 34, the two institutions can share many logistic facilities and resources, such as teachers, food services, student activity center, faculty support services, faculty lounges, administrative offices, buildings, utilities, recreation, grounds, parking, maintenance, janitorial services, safety services, and the like. The tax dollars, endowments, tuition, or other funding used to support college 34 have a corresponding benefit to high school 32, which provides economies of scale and efficiencies to the education process.

To some degree, high school 32 must meld its rules, regulations, policies, and operations to match or be compatible with college 34. For example, high school 32 organizes and operates its class schedules on the same schedule as college 34. Since college 34 generally schedules classes either on Tuesday (U) and Thursday (H) or on Monday (M) and Wednesday (W) and Friday (F), high school 32 will schedule its classes under the same weekly pattern. College 34 provides year-round classes; high school 32 does the same. High school 32 follows the same vacation calendar, holidays, seasonal breaks, and days off as college 34.

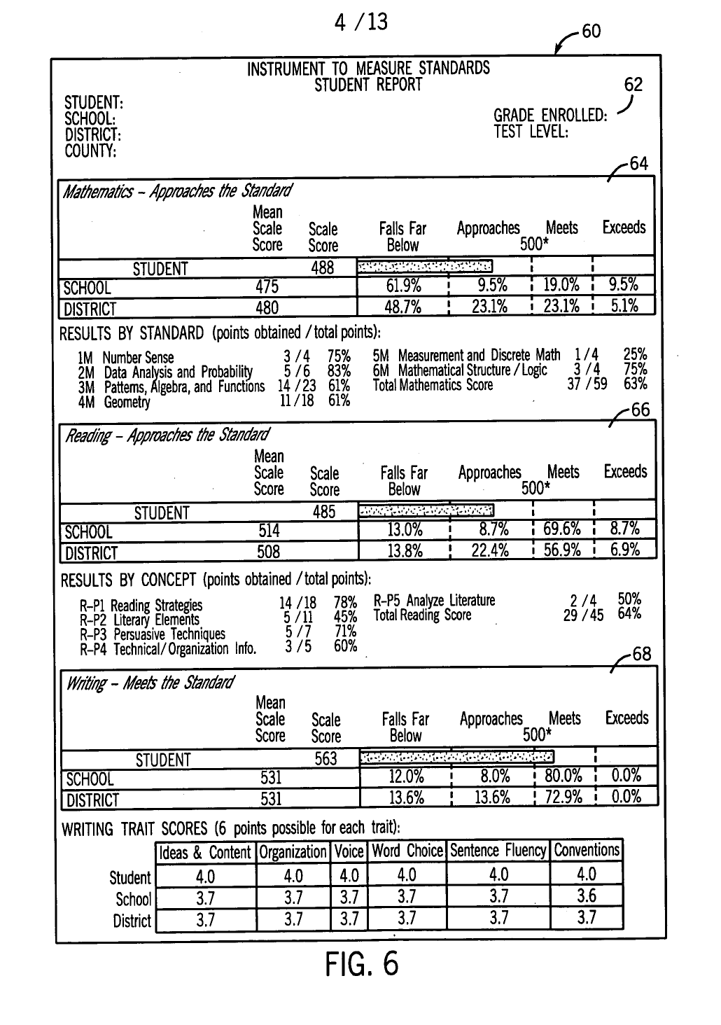

When student 30 enrolls in high school 32, he or she is given a placement or assessment examination in step 40 as shown in FIG. 4. The purpose of the placement exam step 40 is to determine with relative certainty where the student actually resides in terms of academic progress and basic knowledge and learned skills in certain fundamental areas, such as reading, writing, mathematics, sciences, and humanities. In one embodiment, student 30 takes the entrance or placement exam(s) given by each academic department of college 34. In some colleges, this is known as computer adaptive placement assessment (Compass) testing. Compass testing is a comprehensive computerized evaluation that provides important information about individual skills and preparation for college-level courses. The examination is an un-timed, multiple choice, adaptive computer-based test that measures relative skills in at least reading, writing, and mathematics. The Compass test shows the student's score in each tested subject area and automatically generates specific recommendations as to the proper high school or college classes in which to place the student.

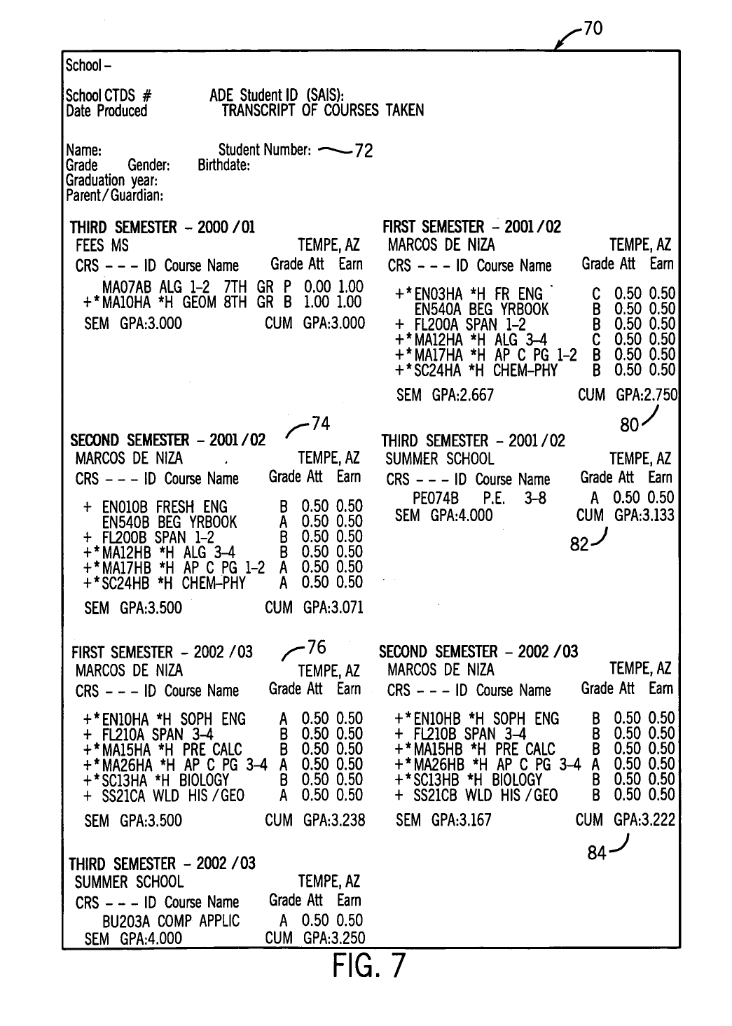

An example of Compass test 50 is shown in FIG. 5. Section 52 contains general background information about the student such as name, identification, prior schools, English as first language, veteran status, etc. Section 54 provides the student's score on the mathematics portion of the test and makes a recommendation for the proper college level math class, e.g., MAT 081/081, MAT 090/091/092, or MAT 102. Section 56 provides the student's score on the college level reading portion of the test and makes a recommendation for the proper reading class, e.g. RDG 091. Section 58 provides the student's score on the writing portion of the test and makes a recommendation for the proper college level writing class, e.g., ENG 101. If the student's assessment test scores are insufficient to qualify for any college class, then a recommendation is made for the high school classes and other special or remedial classes needed to prepare the student for college level classes.

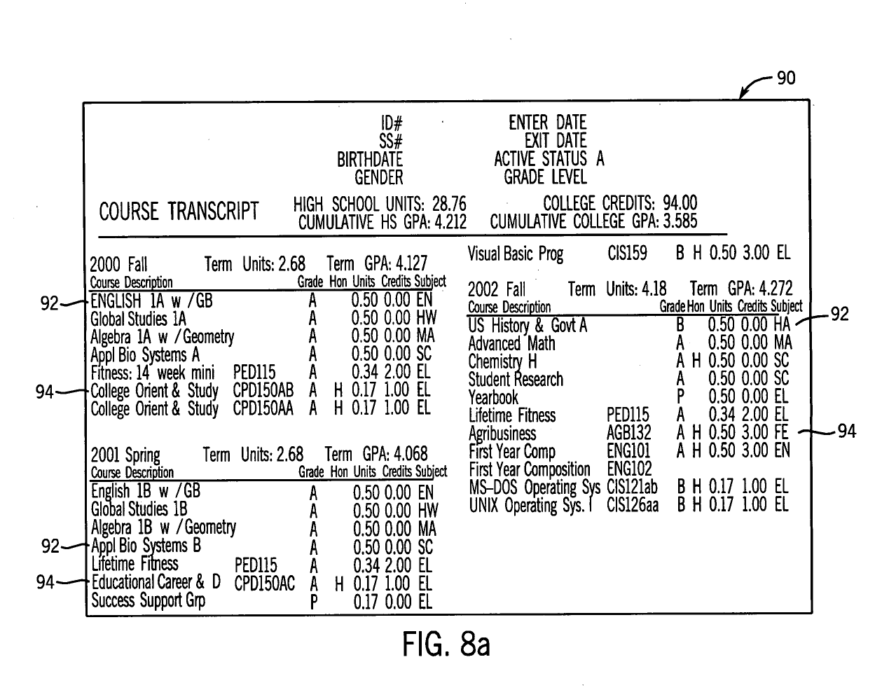

Student 30 may also be given other state and national assessment exams, such as the Arizona Instrument to Measure Standards (AIMS) test and Stanford Achievement Test Ninth Edition (Stanford 9) test. An example of AIMS test 60 is shown in FIG. 6. Section 62 contains general background information about the student such as name, identification, prior schools, district, county, etc. Section 64 provides the student's score on the mathematics portion of the test and provides relative standing with respect to other students. Section 66 provides the student's score on the college level reading portion of the test and provides relative standing with respect to other students. Section 68 provides the student's score on the writing portion of the test and provides relative standing with respect to other students. Other state and national placement or assessment exams also give the student score, relative position to other test takers, and general comments.

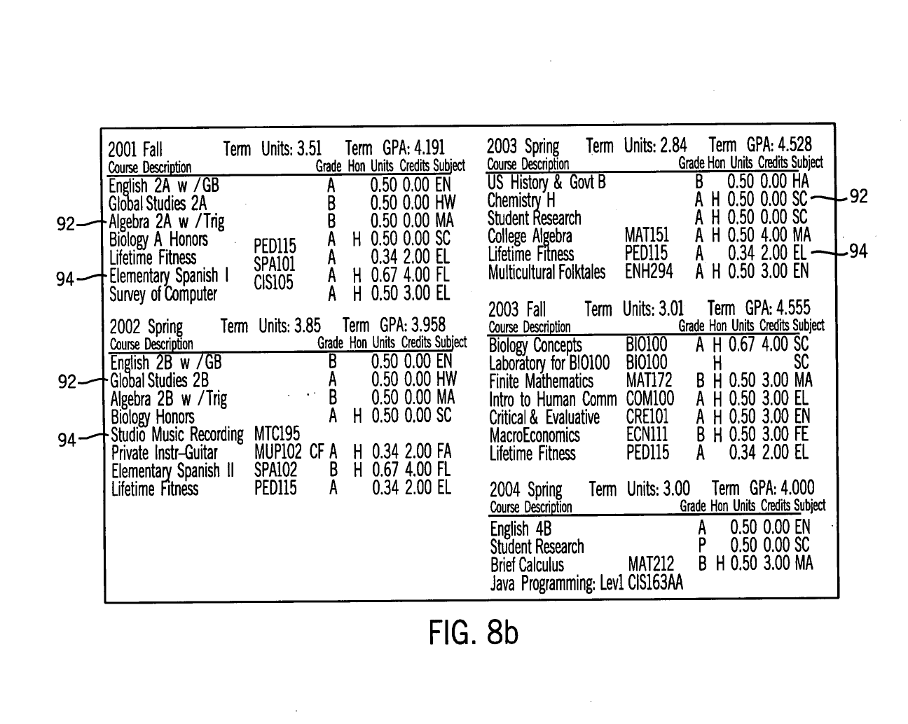

The principal, guidance counselor, or administrator in high school 32 conducts student evaluation in step 42 of FIG. 4 to determine the student's class schedule. The student evaluation step 42 includes consideration of multiple evaluation components, such as placement and assessment exams 40, prior academic transcripts, comments and feedback from prior teachers, interests and goals of the student, and consultation with the parents. An example of prior school transcripts is shown in FIG. 7. Transcripts 70 are illustrative of the course work and achievements of a student transferring from another traditional high school. Section 72 contains general information about the student; section 74 shows grades from one semester; and sections 76-84 shows grades from other semesters.

The components of student evaluation 42 give the administrator of high school 42 the ability to compare and contrast various evaluation data points. One evaluation component alone may be misrepresentative or misleading. The recommendations from the placement test alone are not necessarily determinative, rather it is the combination of the evaluation components, including one or more placement tests and prior school transcripts, as well as discussions with the parents and student, that gives high school 32 the most complete, accurate, and reliable evaluation of the strengths and weakness of student 30. Sometimes the best interests of the student require the administrator to override the recommendation and enroll the student in another course. The student evaluation step 42 is performed one or more times each academic year to track progress.

Based on student evaluation 42, the administrator of high school 32 makes a judgment and decision as to the student's class schedule. When a close judgment call must be made between high school and college class options, the administrator considers maturity, exposure to life experiences, and comfort level of the student in talking to college professors before committing the student to the college class, while always keeping in mind the best interests and placement of the student. In some cases, high school 32 gives student 30 special tutoring on specific subjects, remedial classes, and counseling to complete the prerequisites for college classes. Within reason and without adversely impacting the student's development, high school 32 attempts to get student 30 enrolled in one or more college classes as soon as possible and to take as many college classes as can reasonable be done during their high school years.

One goal of high school 32 is to place student 30 in some combination of high school classes and college classes. The close physical proximity of high school 32 and college 34 makes the integrated curriculum possible. To the extent that student 30 can take a college class that covers at least the same subject matter as a similar high school class, then the student makes progress toward the high school diploma while earning college credit. For example, if the student qualifies to take college freshman English 101, then that coursework will satisfy the high school English requirement toward the high school diploma as well as earn the college credit. Likewise, if the student qualifies to take college freshman Algebra, then that coursework will satisfy the high school mathematics requirement toward the high school diploma as well as earn the college credit. In most cases, the more difficult and comprehensive class of a common subject offered by the college serves to satisfy both the high school requirement and the college requirement. Rather than take two classes at different times as found in traditional educational systems, i.e., one class in high school and one class in college for the same subject, student 30 takes one class in high school 32, the more difficult and comprehensive college class for the requisite course, for both high school and college graduation requirements. The student 30 still takes some high school classes and some college classes. When student 30 is a high school freshman, the ratio of high school classes to college classes may be 90:10. As student 30 reaches their high school senior year, the ratio of high school classes to college classes may be 10:90. Nonetheless, by taking a combination of high school course work and college course work, the student 30 progresses at a rate that challenges their personal development.

Student 30 can expect a more rigorous academic experience under the integrated high school and college program. College course work is across the board more difficult and challenging than high school course work. In college course work, student 30 can expect more hours of homework, faster paced classes, less personal attention from instructors, more difficult class examinations, and great depth of coverage and complexity of subject matter. Yet, the advantages and gains made by student 30 will pay dividends in terms of academic progress, preparation for college, and earning of college credits while still in high school. For those students willing to put forth the effort, the rewards will materialize. If the high school student is capable, interested, and properly motivated, then he or she should be allowed to advance on an individual basis. The integrated high school and college program provides the student such opportunities.

High school 32 offers specialized student instruction, counseling, and aids to prepare high school student 30 to take college classes and otherwise function as college students. The high school student 30 learns college study skills, social interaction skills, time management skills, basic computer skills, and career development skills. The high school student learns how to read a college syllabus and how to talk to college professors. The student aids and special instruction lessens the shock and increases the chances of high school student 30 being successful in the college experience.

In step 44 of FIG. 4, the administrator of high school 32 assigns student 30 his or her class schedule in accordance with the student evaluation 42. The student's class schedule will contain high school course work and college course work depending on his or her aptitude, motivation, and strengths as well as consideration of areas needing further development. A freshman may have 4-5 high school classes and 1-2 college classes. The college classes will be in subjects that satisfy the college requirement as well as a high school requirement. Student 30 attends classes during the semester according to the integrated high school and college class schedule. The student may be in a high school English class on MWF 9:00 am to 10:00 am and a college computer skills class MWF 10:30 to 11:30 am. The student may also be in a high school history class on UT 8:00 am to 9:30 am and a college biology class UT 10:00 to 11:30 am and a high school drama class on UT 1:30 to 3:00 pm. The close proximity of high school 32 to college 34 allows student 30 to move back and forth between classes. Again, the high school classes are held according to the college type class schedule.

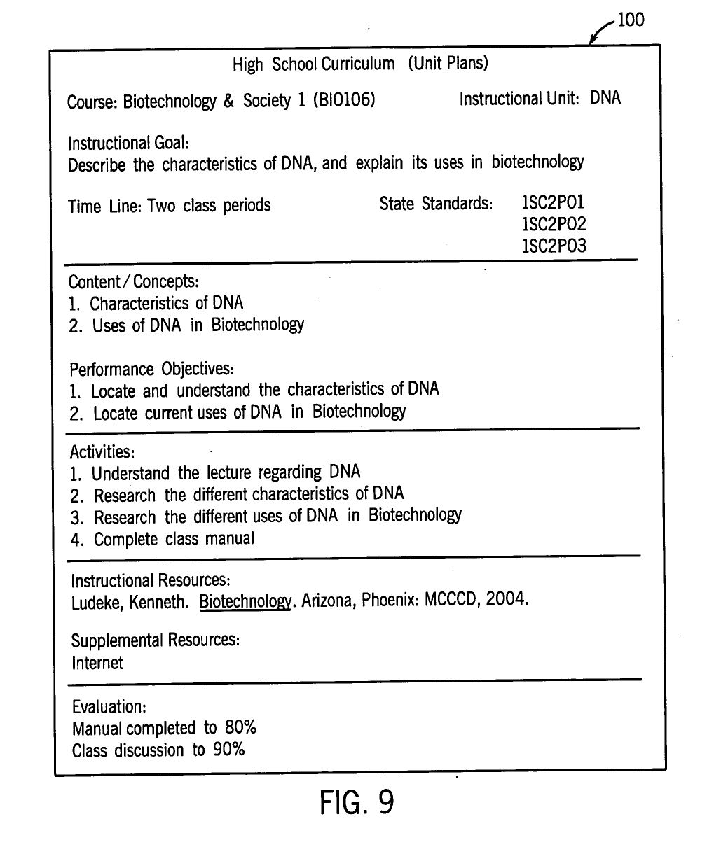

FIGS. 8a and 8b illustrate a high school transcript 90 of student 30 having taken a combination of high school classes and college classes simultaneously over several semesters. For example, class 92 is a high school course and class 94 is a college course. In most cases, each semester has at least one high school course and at least one college class. The ratio of college classes to high school classes increases as the student works through the integrated high school and college curriculum.

The college preparatory charter high school forum 32 may also offer specialized classes of use and interest to the student. High school 32 may offer special expertise or concentrations in biotechnology, electronics, drama, music, or architecture, just to name a few. In the present example, high school 32 offers biotechnology classes in areas such as genetics, botanical gardens, and bio systems. The specialized classes give students an exposure to real world workplaces and industry issues.

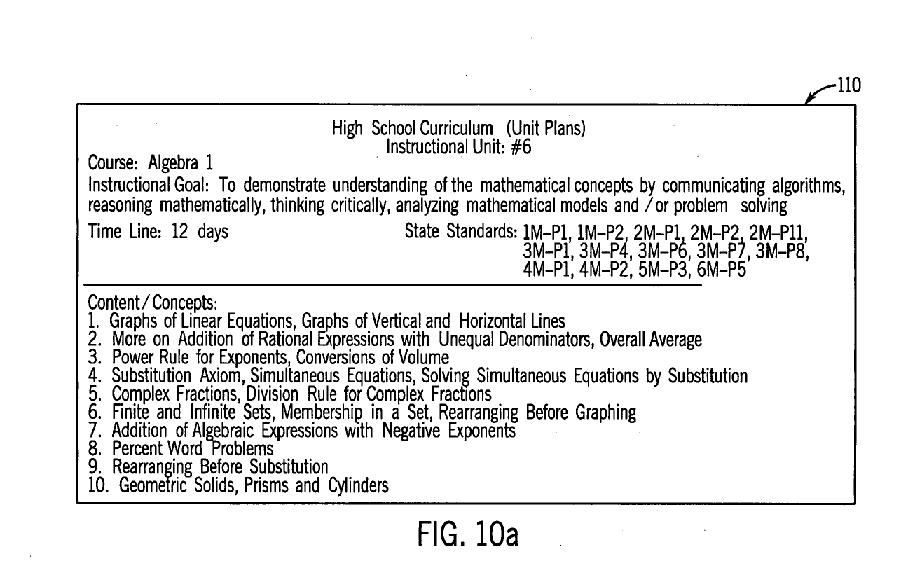

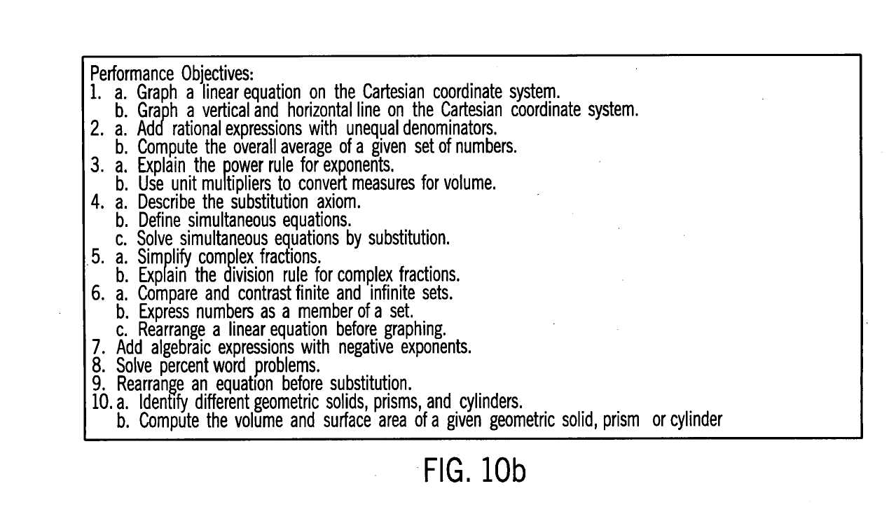

The selection of staff is important to high school 32. Because of its unique approach, high school 32 attracts highly qualified staff and instructors. Teachers migrate to schools where students want to learn and where they have the freedom to teach in an effective, efficient, and flexible environment. Each year, high school 32 reviews its curriculum and makes changes as necessary to maintain compatibility with college 34 and keep its students challenged and motivated. FIG. 9 illustrates a lesson plan 100 for a biotechnology class offered in high school 32. FIGS. 10a-10c illustrate a lesson plan 110 for an algebra class offered in high school 32. The lesson plans 100 and 110 give general guidelines for the instructors, but also allow for flexibility in the manner that the subject is conveyed to the students. Teachers are in the best position to gauge how the students are absorbing the course material and whether to speed up or slow down to optimize the progress. Most teachers appreciate having the freedom to teach.

By the time student 30 graduates from high school 32 with sufficient credits to meet the state high school graduation requirements, he or she can also have a significant number of college credits. In some cases, student 30 can earn 40 or more college credits during a four year high school period. The college credits are transferable into most, if not all, community colleges or four year universities. The earned college credits can be used for the benefit of the student in a variety of ways to enhance the college experience.

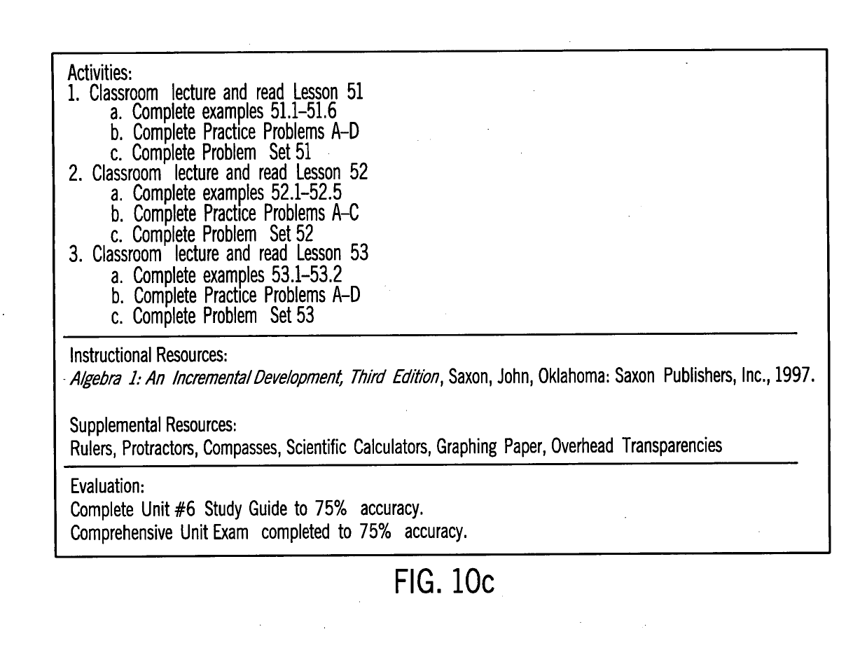

The process of integrating high school and college curriculum to allow a student to receive a high school diploma and earn college credit is shown in FIG. 11. In step 120, the high school is located in proximity to a college campus. The high school and college share resources and facilities. In step 122, the student is evaluated to ascertain academic aptitudes and capabilities. The student is evaluated by administering a college placement exam and by reviewing prior school transcripts. In step 124, a class schedule is assigned to the student based on the evaluation of the student. The class schedule has at least one high school class and at least one college class. The class schedule is assigned by an administrator of the high school based on the evaluation of the student. The high school class is scheduled in accordance with the college class. In step 126, the high school forum is organized and operates so as to allow the student to attend the high school class in the high school and attends the college class on the college campus according to the class schedule. The high school offers special classes for the student to adapt to the college class. In step 128, the high school student earns college credit upon passing the college class.

The integrated high school and college program can be implemented as one or more software applications or computer programs residing and operating on a computer system. The computer system may be a stand-alone unit or part of a distributed computer network. The computer is typically electronically interconnected with other computers using communication links such as Ethernet, radio frequency (RF), satellite, telephone lines, optical, digital subscriber line, cable connection, wireless, and other recognized communication standards. The electronic connection link between computers can be made through an open architecture system such as the World Wide Web, commonly known as the Internet. The Internet offers a significant capability to share information, data, and software.

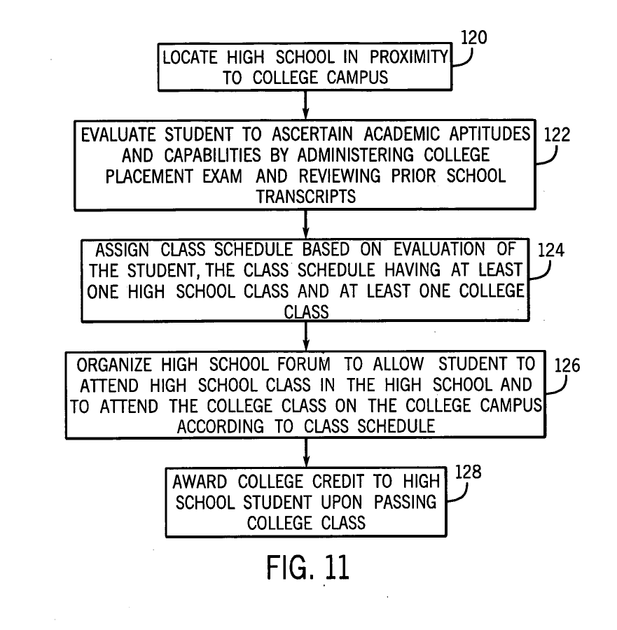

FIG. 12 illustrates a simplified computer system 150 for executing the software program used in integrating the high school and college curriculums. Computer system 150 is a general purpose computer including a central processing unit or microprocessor 152, mass storage device or hard disk 154, electronic memory 156, and communication port 158. Communication port 158 represents a modem, high-speed Ethernet link, or other electronic connection to transmit and receive input/output (I/O) data with respect to other computer systems.

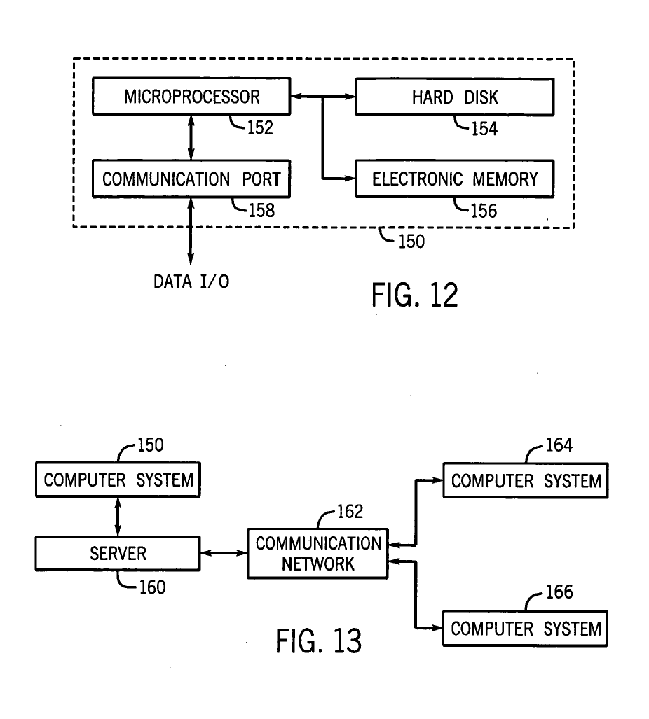

In FIG. 13, computer 150 is shown connected to server 160 by way of communication port 158, which in turn is connected to communication network 162. Server 160 operates as a system controller and includes mass storage devices, operating system, and communication links for interfacing with communication network 162. Communication network 162 can be a local and secure communication network such as an Ethernet network, global secure network, or open architecture such as the Internet. Computer systems 164 and 166 can be configured as shown for computer 160 or dedicated and secure data entry terminals. Computers 164 and 166 are also connected to communication network 162. Computers 160, 164, and 166 transmit and receive information and data over communication network 162.

Each of the computers runs application software and computer programs, which can be used to display user interface screens, execute the functionality, and provide the features as described above. The software is originally provided on computer readable media, such as compact disks (CDs), magnetic tape, or other mass storage medium. Alternatively, the software is downloaded from electronic links such as the host or vendor website. The software is installed onto the computer system hard drive 154 and/or electronic memory 156, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. The software contains one or more programming modules, subroutines, computer links, and compilation of executable code which performs the functionality of the integrated high school and college program. The user interacts with the software via keyboard, mouse, voice recognition, and other user interface devices to the computer system.

The software stores information and data generated by the integrated high school and college program in a database or file structure located on any one of, or combination of, hard drives 84 of the computers 150, 164, 166, and/or server 160. More generally, the information generated during the process of conducting an integrated high school and college curriculum can be stored on any mass storage device accessible to the computers 150, 164, 166, and/or server 160. The mass storage device for storing data from the integrated high school and college program may be part of a distributed computer system.

The integrated high school and college program offers many advantages for the student and schools alike. The student remains challenged and motivated, progresses much faster, receives their high school diploma, earns college credits, and has a high probability of actually attending college after high school and doing well. By integrating high school and college, the students are in a sense automatically drawn into the college scene after high school by the inertia of the program. The fact of having college credits under one's belt is motivation and incentive to continue on to earn the college degree, i.e., it almost takes more effort to stop than to keep going. The college credits themselves have limited value until the student turns them into a college degree. Most students are reluctant to give up college credits that they have already earned, so the natural step is to continue on to college.

The high school benefits from the integrated high school and college program by sharing logistical resources with the college, reducing overall student load as the college classes serve the purpose of satisfying both high school and college requirements, providing an enjoyable teaching environment, and keeping the students interested and progressing.

While one or more embodiments of the present invention have been illustrated in detail, the skilled artisan will appreciate that modifications and adaptations to those embodiments may be made without departing from the scope of the present invention as set forth in the following claims.

1. A method of integrating high school and college curriculum to allow a student to receive a high school diploma and earn college credit, comprising:
providing a high school in proximity to a college campus;
evaluating a student to ascertain academic aptitudes and capabilities;
assigning a class schedule to the student based on the evaluation of the student, the class schedule having at least one high school class and at least one college class; and
organizing a high school forum, wherein the student attends the high school class in the high school and attends the college class on the college campus according to the class schedule.

2. The method of claim 1, wherein the student earns college credit upon passing the college class.

3. The method of claim 1, wherein evaluating the student includes administering a college placement exam.

4. The method of claim 1, wherein evaluating the student includes reviewing prior school transcripts.

5. The method of claim 1, wherein the high school is co-located on the college campus.

6. The method of claim 5, wherein the high school and college share resources and facilities.

7. The method of claim 1, wherein the high school class is scheduled in accordance with the college class.

8. The method of claim 1, further including offering special classes for the student to adapt to the college class.

9. The method of claim 1, wherein the class schedule is assigned by an administrator of the high school based on the evaluation of the student.

10. A computer implemented method of providing a high school forum integrated with a college curriculum, comprising:
administering an assessment test to high school students at least once per year;
evaluating the high school student based on the assessment test to determine a class schedule based on academic aptitudes and capabilities, the class schedule having a high school class and a college class; and
organizing the high school forum in a manner to allow the student to attend the high school class and college class according to the class schedule.

11. The computer implemented method of claim 10, further including providing the high school forum in proximity to a college campus.

12. The computer implemented method of claim 10, wherein the student earns college credit upon passing the college class.

13. The computer implemented method of claim 10, wherein evaluating the student further includes reviewing prior school transcripts.

14. A method of educating a high school student in a high school forum located in proximity to a college campus, comprising:
assessing academic competence of the high school student by administering an assessment test;
assigning a class schedule to the high school student based on the academic competence, the class schedule having a high school class and a college class;
organizing the high school forum so that the high school student attends the high school class under the high school forum and the college class on the college campus; and
awarding college credit to the high school student upon passing the college class.

15. The method of claim 14, wherein assessing academic competence of the high school student includes reviewing prior school transcripts.

16. The method of claim 14, wherein the high school forum is co-located on the college campus.

17. The method of claim 16, wherein the high school forum and college campus share resources and facilities.

18. The method of claim 14, wherein the high school class is scheduled in accordance with the college class.

19. The method of claim 4, further including offering special classes for the high school student to adapt to the college class.

20. The method of claim 14, wherein the class schedule is assigned by an administrator of the high school forum based on the assessment of the high school student.

21. An integrating high school and college program which allows a student to receive a high school diploma and earn college credit, comprising:
means for providing a high school in proximity to a college campus;
means for evaluating a student to ascertain academic aptitudes and capabilities;
means for assigning a class schedule to the student based on the evaluation of the student, the class schedule having at least one high school class and at least one college class; and
means for organizing a high school forum, wherein the student attends the high school class in the high school and attends the college class on the college campus according to the class schedule.

22. The integrating high school and college program of claim 21, wherein the student earns college credit upon passing the college class.

23. The integrating high school and college program of claim 21, further including means for administering a college placement exam.

24. The integrating high school and college program of claim 21, further including means for reviewing prior school transcripts.

25. The integrating high school and college program of claim 21 wherein the high school class is scheduled in accordance with the college class.

26. The integrating high school and college program of claim 21, further including means for offering special classes for the student to adapt to the college class.
